(19) United States
(12) Patent Application Publication
(10) Pub. No.: US 2020/0275650 A1
(43) Pub. Date: Sep. 3, 2020

(54) NOVEL POLYMER COATED CHLOROTHALONIL PARTICLES

(71) Applicant: The University of Sydney, New South Wales (AU)

(72) Inventors: James Burns, Bracknell (GB); Tim Powell, Bracknell (GB); Alexander Mark Heming, Basel (CH); Brian Stanley Hawkett, New South Wales (AU); Ngoc Duc Nguyen, New South Wales (AU); The Vien Huynh, New South Wales (AU)

(21) Appl. No.: 16/759,512

(22) PCT Filed: Oct. 31, 2018
(86) PCT No.: PCT/AU2018/051172

§ 371 Date: Apr. 27, 2020

(30) Foreign Application Priority Data
Oct. 31, 2017 (AU) 2017904421

(51) Int. Cl. A01N 25/26; A01N 37/34; A01N 25/32; C08F 220/14; C08F 293/00

(52) U.S. Cl. CPC A01N 25/26; A01N 37/34; C08F 2438/03; C08F 220/14; C08F 293/005; A01N 25/32

(57) ABSTRACT

The present invention relates to novel polymer coated chlorothalonil particles, processes for their preparation, agricultural compositions containing them and to methods of using them for controlling or preventing infestation of useful plants by phytopathogenic microorganisms.

### FIELD OF THE INVENTION

The present invention relates to novel polymer coated chlorothalonil particles, processes for their preparation, agricultural compositions containing them and to methods of using them for controlling or preventing infestation of useful plants by phytopathogenic microorganisms.

### BACKGROUND OF THE INVENTION

Chlorothalonil is a well-known fungicide which is widely used in the control of many fungal diseases in a wide range of crops. The acute inhalation toxicity of Chlorothalonil is well documented (Median Lethal Concentration for technical chlorothalonil=0.1 mg/L) principally mediated through respiratory irritancy. Thus, there is a clear benefit in reducing the level of inhalation toxicity for chlorothalonil containing products.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

It has now surprisingly been found that by coating chlorothalonil particles in a specific manner the level of inhalation toxicity can be significantly reduced. Hence, in a first aspect, as embodiment 1, the present invention relates to a

coated chlorothalonil particle comprising

a chlorothalonil particle, and

a polymer coating on the surface of the chlorothalonil particle,

wherein the polymer coating comprises a Reversible Addition-Fragmentation chain Transfer (RAFT) agent.

Furthermore, it has been surprisingly found that this reduction of inhalation toxicity can be achieved according to the present invention without compromising the fungicidal activity of chlorothalonil.

As used herein, except where the context requires otherwise, the term “comprise” and variations of the term, such as “comprising”, “comprises” and “comprised”, are not intended to exclude further additives, components, integers or steps.

### DETAILED DESCRIPTION OF THE EMBODIMENTS

In order to obtain coated chlorothalonil particles as defined above, the polymer has been coated on the surface of the chlorothalonil particles under the control of a Reversible Addition-Fragmentation chain Transfer (RAFT) agent, i.e. RAFT agent. RAFT polymerization and RAFT agents are generally known to those skilled in the art. For example, suitable RAFT agents for use in the present invention include but are not limited to the ones described in WO2006/037161 and WO2007/112503. The polymer coating on the surface of the chlorothalonil particles under the control of a RAFT agent as described in WO2006/037161 and WO2007/112503 enables the polymer to be formed at the surface in a substantially controllable and reproducible manner. RAFT agents according to the present invention fulfill two important functions:

controlling the formation of polymer on the surface of the chlorothalonil particles,

stabilizing the suspension of chlorothalonil particles where the polymerization takes place.

The RAFT agent used in the present invention is physically associated with the surface of the chlorothalonil particles. In particular, the RAFT agent is at least partially adsorbed onto the outermost surface of the particulate material. By having the ability to be adsorbed onto the outermost surface of the chlorothalonil particles, the RAFT agents exhibit some surface activity. Hence, a RAFT agent according to the present invention has a structure that enables it to

be partially adsorbed onto the outermost surface of the chlorothalonil particles instead of being entirely solvated in the reaction solution,

be a stabilizer for the chlorothalonil particles in the reaction solution, i.e. preventing the chlorothalonil particles from flocculation or sedimentation,

control the polymerization process on the surface of the chlorothalonil particles.

Preferred embodiments in relation to the first aspect of the present invention are as set out below in embodiments 2 to 14.

In embodiment 2 of the first aspect of the invention, there is provided a coated chlorothalonil particle according to embodiment 1, where the RAFT agent is of formula (I)

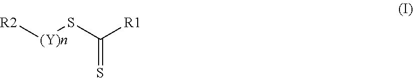

wherein

each Y is independently selected from a polymerized residue of an ethylenically unsaturated monomer;

n is an integer ranging from 0 to 100;

R1 is selected from C₁₋₂₀ alkyl, C₁₋₂₀ alkoxy, aryloxy, aryl, aryl C₁₋₂₀ alkyl, heterocyclyl, heterocyclyl C₁₋₂₀ alkyl, C₁₋₂₀ alkyl heterocyclyl, C₁₋₂₀ alkyl aryl, C₁₋₂₀ alkylthio, aryl C₁₋₂₀ alkylthio, —P(═O)(OC₁₋₂₀ alkyl)₂, —P(═O)(C₁₋₂₀ alkyl)₂, —C(═O)OR′, —C(═O)NH₂, —C(═O)(C(═NH)R^{1a}) and —NR^{1a}R^{1b}, wherein R^{1a} and R^{1b} are C₁₋₂₀ alkyl, or R^{1a} and R^{1b} together with the N atom to which they are attached form a heterocyclyl ring, and wherein each R1 is unsubstituted or substituted with a substituent independently selected from —C(═O)OH, —SO₃H, —OSO₃H, —OP(OH)₂, —P(OH)₂, —PO(OH)₂, —OH, ═O, —CONH₂, —CONHR′, —CONR′R″, —NR′R″ and —N⁺R′R″R′″;

R2 is selected from C₁₋₆ alkyl, C₁₋₆ alkoxy, aryl or heteroaryl, each of which is substituted with one or more substituent independently selected from —C(═O)OH, —C(═O)OR′, —C(═O)OR^{2a}NR′R″, —SOR^{2a}NR′R″, —SO₂R^{2a}NR′R″, —SO₃H, —CN, —OSO₃H, —OP(OH)₂, —P(OH)₂, —PO(OH)₂, —OH, —OR^{2a}NR′R″, —(OCH₂—CHR′)_{w}—OH, —CONH₂, —CONHR′, —CONR′R″, —NR′R″ and —N⁺R′R″R′″;

R^{2a} is C₁₋₆ alkyl;

w is an integer ranging from 1 to 10;

R′, R″ and R′″ are each independently C₁₋₆ alkyl which is unsubstituted or substituted with one or more hydrophilic substituents, preferably independently selected from —C(═O)OH, —SO₃H, —OSO₃H, —OP(OH)₂, —P(OH)₂, —PO(OH)₂, —OH and —CONH₂.

As a skilled person is well aware, the number n in a compound of formula (I) (if n is not 0) refers to a degree of polymerization which has dispersity and thus n represents the number average.

In embodiment 3 of the first aspect of the invention, there is provided a coated chlorothalonil particle according to embodiment 2, wherein

R1 is selected from C₁₋₂₀ alkyl, aryl C₁₋₂₀ alkyl, C₁₋₂₀ alkylthio, aryl C₁₋₂₀ alkylthio and-NR^{1a}R^{1b}, wherein R^{1a} and R^{1b} are C₁₋₂₀ alkyl, or R^{1a} and R^{1b} together with the N atom to which they are attached form a heterocyclyl ring, and wherein each R1 is unsubstituted or substituted with a substituent independently selected from —C(═O)OH, —SO₃H, —OSO₃H, —OP(OH)₂, —P(OH)₂, —PO(OH)₂, —OH, —CONH₂, —CONHR′, —CONR′R″, —NR′R″ and —N⁺R′R″R′″;

R2 is selected from C₁₋₆ alkyl, C₁₋₆ alkoxy aryl or heteroaryl, each of which is substituted with one or more substituent independently selected from —C(═O)OH, —CN, —CONH₂, —CONHR′ and -CONR′R″;

R′, R″ and R′″ are independently C₁₋₆ alkyl which is unsubstituted or substituted with one or more hydrophilic substituents, preferably independently selected from —C(═O)OH, —SO₃H, —OSO₃H, —OP(OH)₂, —P(OH)₂, —PO(OH)₂, —OH and —CONH₂.

In embodiment 4 of the first aspect of the invention, there is provided a coated chlorothalonil particle according to embodiment 3, wherein

R1 is selected from C₁₋₁₀ alkyl and C₁₋₁₀ alkylthio, wherein each R1 is unsubstituted or substituted with a substituent independently selected from —C(═O)OH, —CN, —SO₃H, —OSO₃H, —OP(OH)₂, —P(OH)₂, —PO(OH)₂, —OH, —CONH₂, —CONHR′, —CONR′R″, —NR′R″ and —N⁺R′R″R′″;

R2 is selected from C₁₋₆ alkyl, each of which is substituted with one or more substituent independently selected from —C(═O)OH, —CON H₂ and CN;

R′, R″ and R′″ are independently C₁₋₆ alkyl which is unsubstituted or substituted with one or more hydrophilic substituents, preferably independently selected from —C(═O)OH, —SO₃H, —OSO₃H, —OP(OH)₂, —P(OH)₂, —PO(OH)₂, —OH and —CONH₂.

In embodiment 5 of the first aspect of the invention, there is provided a coated chlorothalonil particle according to any one of embodiments 1 or 2, wherein the RAFT agent is of formula

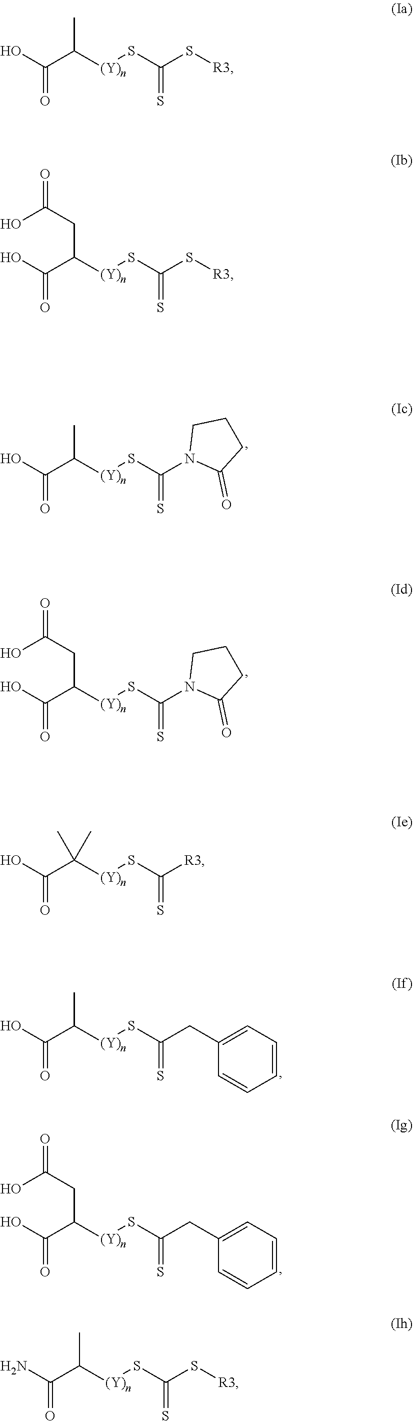

wherein R3 is C₁₋₆ alkyl which is unsubstituted or substituted with one or more (hydrophilic) substituents independently selected from —C(═O)OH, —SO₃H, —OSO₃H, —OP(OH)₂, —P(OH)₂, —PO(OH)₂, —OH, —CONH₂, —CONHR′, —CONR′R″, —NR′R″ and —N⁺R′R″R′″;

R′, R″ and R′″ are each independently C₁₋₆ alkyl which is unsubstituted or substituted with one or more (hydrophilic) substituents independently selected from —C(═O)OH, —SO₃H, —OSO₃H, —OP(OH)₂, —P(OH)₂, —PO(OH)₂, —OH and —CONH₂;

each Y is independently selected from a polymerized residue of an ethylenically unsaturated monomer;

n is an integer ranging from 0 to 100.

In embodiment 6 of the first aspect of the invention, there is provided a coated chlorothalonil particle according to any one of embodiments 2 to 5, wherein

each Y is a polymerized residue of an ethylenically unsaturated monomer of formula (II)

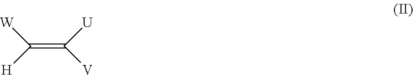

wherein

W and U are independently selected from H, halogen, —C(═O)OH, —C(═O)OR^{Y}, —C(═O)R^{Y}, —CSR^{Y}, —CSOR^{Y}, —C(═O)SR^{Y}, —C(═O)NH₂, —C(═O)NHR^{Y}, —C(═O)N(R^{Y})₂, C₁₋₆ alkyl which is unsubstituted or substituted with a substituent independently selected from —OH, —C(═O)OH, —C(═O)OR^{Y}, C(═O)R^{Y}, —CSR^{Y}, —CSOR^{Y}, —C(═O)SR^{Y}, —C(═O)NH₂, —C(═O)NHR^{Y}, —C(═O)N(R^{Y})₂, —O(R^{Y})₂, —SR^{Y}, —SC(═O)R^{Y} and —OCSR^{Y};

V is selected from H, R^{Y}, —C(═O)OH, —C(═O)OR^{Y}, —C(═O)R^{Y}, —CSR^{Y}, —CSOR^{Y}, —C(═O)SR^{Y}, —C(═O)NH₂, —C(═O)NHR^{Y}, —C(═O)N(R^{Y})₂, —OR^{Y}, —SR^{Y}, SC(═O)R^{Y} and —OCSR^{Y};

R^{Y} is selected from C₁₋₂₀ alkyl, C₁₋₂₀ alkenyl, aryl, heteroaryl, heterocyclyl, C₁₋₈ cycloalkyl, aryl C₁₋₂₀ alkyl, C₁₋₂₀ alkyl aryl, heteroaryl C₁₋₂₀ alkyl, C₁₋₂₀ alkyl heteroaryl, wherein each R^{Y} is unsubstituted or substituted with a substituent independently selected from epoxy, oxy, hydroxy, C₁₋₂₀ alkoxy, sulfonic acid, —C(═O) C₁₋₂₀ alkyl, —C(═O) OC₁₋₂₀ alkyl, —C(═O)H, —C(═O)O aryl, isocyanato, cyano, halogen, silyl and amino.

A person skilled in the art would appreciate that the ethylenically unsaturated monomers may be present in the suspension as salts, for example as sodium, potassium or ammonium salts.

In embodiment 6.1 of the first aspect of the invention, there is provided a coated chlorothalonil particle according to any one of embodiments 2 to 6, wherein each Y is a polymerized residue of an ethylenically unsaturated monomer independently selected from methyl methacrylate, ethyl methacrylate, propyl methacrylate, butyl methyacrylate, 2-ethyl-hexyl methacrylate, isobornyl methacrylate, methacrylic acid, benzyl methacrylate, phenyl methacrylate, methyl acrylate, ethyl acrylate, propyl acrylate, butyl acrylate, 2-ethyl-hexyl acrylate, isobornyl acrylate, acrylic acid, benzyl acrylate, phenyl acrylate, sulfomethyl methacrylate, sulfoethyl methacrylate, sulfopropyl methacrylate, sulfobutyl methacrylate, sulfomethyl acrylate, sulfoethyl acrylate, sulfopropyl acrylate, sulfobutyl acrylate, methacrylonitrile, alpha-methylstyrene, acrylonitrile, styrene, glycidyl methacrylate, 2-hydroxyethyl methacrylate, hydroxypropyl methacrylate, hydroxybutyl methacrylate, N,N,-dimethylaminoethyl methacrylate, N,N-diethylaminoethyl methacrylate, triethyleneglycol methacrylate, itaconic anhydride, itaconic acid, glcidyl acrylate, 2-hydroxyethyl acrylate, hydroxypropyl acrylate, hydroxybutyl acrylate, N,N-dimethylaminoethyl acrylate, N,N-diethylaminoethyl acrylate, triethyleneglycol acrylate, methacrylamide, N-methylacrylamide, N,N-dimethylacrylamide, N-tert-butylmethacrylamide, N-n-butylmethacrylamide, N-methylolmethacrylamide, N-ethylolmethacrylamide, N-tert-butylacrylamide, N-methylolmethacrylamide, N-ethylolacrylamide, vinyl benzoic acid, diethylamino styrene, alpha-methylvinyl benzoic acid, diethylamino alpha-methylstyrene, p-vinylbenzene sulfonic acid, p-vinylbenzene sulfonic sodium salt, trimethoxysilylpropyl methacrylate, triethoxysilylpropyl methacrylate, tribtoxysilylpropyl methacrylate, dimethoxymethylsilylpropyl methacrylate, diethoymethylslylpropyl methacrylate, di butoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisoopropoxysilylpropyl methacrylate, trimethoxysilylpropyl acrylate, triethoxysilylpropyl acrylate, tributoxysilylpropylacrylate, dimethoxymethylsilylpropyl methacrylate, diethoxymethylsilylpropyl acrylate, dibutoxymethylsilylpropyl acrylate, diisoprpoxymethylsilylpropyl acrylate, dimethoxysilylpropyl acrylate, diethoxysilylpropl acrylate, dibutoxysilyl propyl acrylate, diisoppoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, butadiene, ethylene and chloroprene. A skilled person is well aware that there might be further monomers suitable for use in the present invention.

In embodiment 6.2 of the first aspect of the invention, there is provided a coated chlorothalonil particle according to any one of embodiments 2 to 6, wherein each Y is a polymerized residue of an ethylenically unsaturated monomer independently selected from acrylic acid, n-butyl acrylate, 2-sulfoethyl methacrylate and methyl methacrylate.

In embodiment 7 of the first aspect of the invention, there is provided a coated chlorothalonil particle according to any one of embodiments 2 to 6, wherein n is ranging from 0 to 50, preferably from 10 to 50, more preferably from 10 to 30.

In embodiment 8 of the first aspect of the invention, there is provided a coated chlorothalonil particle according to embodiments 1 or 2, wherein the RAFT agent is of formula (Ia)

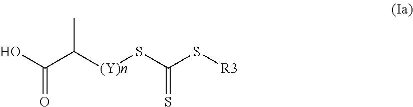

wherein

R3 is C₁₋₆ alkyl which is unsubstituted or substituted with one or more (hydrophilic) substituents independently selected from —C(═O)OH, —SO₃H, —OSO₃H, —OP(OH)₂, —P(OH)₂, —PO(OH)₂, —OH, —CONH₂, —CONHR′, —CONR′R″, —NR′R″ and —N⁺R′R″R′″;

R′, R″ and R′″ are C₁₋₆ alkyl which is unsubstituted or substituted with one or more (hydrophilic) substituents independently selected from —C(═O)OH, —SO₃H, —OSO₃H, —OP(OH)₂, —P(OH)₂, —PO(OH)₂, —OH, —CONH₂;

each Y is a polymerized residue of an ethylenically unsaturated monomer independently selected from methyl methacrylate, ethyl methacrylate, propyl methacrylate, butyl methyacrylate, 2-ethyl-hexyl methacrylate, isobornyl methacrylate, methacrylic acid, benzyl methacrylate, phenyl methacrylate, methyl acrylate, ethyl acrylate, propyl acrylate, butyl acrylate, 2-ethyl-hexyl acrylate, isobornyl acrylate, acrylic acid, benzyl acrylate, phenyl acrylate, sulfomethyl methacrylate, sulfoethyl methacrylate, sulfopropyl methacrylate, sulfobutyl methacrylate, sulfomethyl acrylate, sulfoethyl acrylate, sulfopropyl acrylate and sulfobutyl acrylate, styrene, styrene sulfonate;

n is from 0 to 100.

In embodiment 9 of the first aspect of the invention, the RAFT agent is as defined in embodiment 8 wherein

R3 is unsubstituted C₁₋₆ alkyl;

Y is a polymerized residue of one or more unsaturated monomers independently selected from acrylic acid, methyl methacrylate, butyl acrylate and 2-sulfoethyl methacrylate;

n is from 10 to 30.

In embodiment 10 of the first aspect of the invention, the RAFT agent is as defined in embodiment 8 or 9 wherein R3 is butyl, preferably n-butyl.

In embodiment 11 of the first aspect of the invention, the RAFT agent is as defined in embodiment 10 wherein the RAFT agent is of the type 2-{[(butylsulfanyl)carbonothioyl] sulfanyl} propanoic acid and wherein Y is selected from n-butyl acrylate, acrylic acid and 2-sulfoethyl methacrylate.

In embodiment 12 of the first aspect of the invention, the RAFT agent is as defined in embodiment 11 wherein the RAFT agent is of the type 2-{[(butylsulfanyl)carbonothioyl]sulfanyl}propanoic acid:

(BuPATTC)-((n-butyl acrylate)ₘ-co-(acrylic acid)ₓ-co-(2-sulfoethyl methacrylate)_{y}), and wherein the average degree of polymerization is m≈8, x≈5 and y≈5.

In a further embodiment 13 of the first aspect of the invention, the number average particle size distribution of the chlorothalonil particles according to any one of embodiments 1 to 12 as measured using laser light diffraction is between 10 nm and 100 μm, preferably between 100 nm and 10 μm, more preferably between 1 μm and 3 μm. The number average particle size distribution has been measured using a Malvern Mastersizer 2000 particle size analyzer, with a particle refractive index of 1.6 and absorption of 0.01.

In embodiment 14 of the present invention, the weight % of polymer coating on the surface of the chlorothalonil particles according to any one of embodiments 1 to 13 is between 2 and 12%, preferably between 2 and 10%, more preferably between 2 and 6%, of the total weight of the coated chlorothalonil particle.

RAFT agents according to formula (I) and (Ia)-(Ih) may be prepared according to methods known by the skilled person. Generally, they are prepared by polymerizing ethylenically unsaturated monomers under the control of a compound of formula (III)

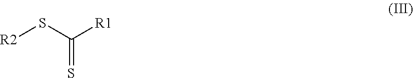

wherein R1 and R2 are as defined in any one of embodiments 2 to 4.

Definitions:

The term “Alkyl” as used herein—in isolation or as part of a chemical group—represents straight-chain or branched hydrocarbons, preferably with 1 bis 6 carbon atoms, for example methyl, ethyl, n-propyl, isopropyl, n-butyl, isobutyl, s-butyl, t-butyl, pentyl, 1-methylbutyl, 2-methylbutyl, 3-methylbutyl, 1,2-dimethylpropyl, 1,1-dimethylpropyl, 2,2-dimethylpropyl, 1-ethylpropyl, hexyl, 1-methylpentyl, 2-methylpentyl, 3-methylpentyl, 4-methylpentyl, 1,2-dimethylpropyl, 1,3-dimethylbutyl, 1,4-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl and 2-ethylbutyl. Alkyl groups with 1 to 4 carbon atoms are preferred, for example methyl, ethyl, n-propyl, isopropyl, n-butyl, isobutyl, s-butyl or t-butyl.

The term “alkoxy” represents straight or branched chain —O-alkyl, wherein alkyl is as defined above, preferably having 1 to 6 carbon atoms, for example methoxy, ethoxy, n-propoxy, isopropoxy, n-butoxy, isobutoxy, s-butoxy and t-butoxy. Alkoxy having 1 to 4 carbon atoms are preferred.

The term “aryl” represents a mono-, bi- or polycyclical aromatic system with preferably 6 to 14, more preferably 6 to 10 ring-carbon atoms, for example phenyl, naphthyl, anthryl, phenanthrenyl, preferably phenyl. “Aryl” also represents polycyclic systems, for example tetrahydronaphtyl, indenyl, indanyl, fluorenyl, biphenyl. “Arylalkyls” are examples of substituted aryls, which may be further substituted with the same or different substituents both at the aryl or alkyl part. Benzyl and 1-phenylethyl are examples of such arylalkyls. “Aryloxy” as used herein represent —O-aryl.

The term “heterocyclyl”, “heterocyclic ring” or “heterocyclic ring system” represents a carbocyclic ring system with at least one ring, in which ring at least one carbon atom is replaced by a heteroatom, preferably selected from N, O, S, P, B, Si, Se, and which ring is saturated, unsaturated or partially saturated. Unless otherwise defined, the heterocyclic ring has preferably 3 to 9 ring atoms, preferably 3 to 6 ring atoms, and one or more, preferably 1 to 4, more preferably 1, 2 or 3 heteroatoms in the heterocyclic ring, preferably selected from N, O, and S, wherein no O atoms can be located next to each other. The heterocyclic rings normally contain no more than 4 nitrogens, and/or no more than 2 oxygen atoms and/or no more than 2 sulfur atoms. In case that the heterocyclic substituent or the heterocyclic ring is further substituted, it can be further annulated with other heterocyclic rings.

The term “alkylthio” as used herein represents —S-alkyl.

The term “heteroaryl” represents heteroaromatic groups, i.e. completely unsaturated aromatic heterocyclic groups, which fall under the above definition of heterocycls. “Heteroaryls” with 5 to 7-membered rings with 1 to 3, preferably 1 or 2 of the same or different heteroatoms selected from N, O, and S. Examples of “heteroaryls” are furyl, thienyl, pyrazolyl, imidazolyl, 1,2,3- and 1,2,4-triazolyl, isoxazolyl, thiazolyl, isothiazolyl, 1,2,3-, 1,3,4-, 1,2,4- and 1,2,5-oxadiazolyl, azepinyl, pyrrolyl, pyridyl, pyridazinyl, pyrimidinyl, pyrazinyl, 1,3,5-, 1,2,4- and 1,2,3-triazinyl, 1,2,4-, 1,3,2-, 1,3,6- and 1,2,6-oxazinyl, oxepinyl, thiepinyl, 1,2,4-triazolonyl and 1,2,4-diazepinyl.

As used herein, when one embodiment refers to several other embodiments by using the term “according to any one of”, for example “according to any one of embodiments 1 to 23”, then said embodiment refers not only to embodiments indicated by integers such as 1 and 2 but also to embodiments indicated by numbers with a decimal component such as 23.1, 23.2, 23.3, 23.4, 23.20, 23.25, 23.30.

Compounds of formula (III) are the same as RAFT agents of formula (I) when n is 0. As mentioned previously, RAFT agents must be able to stabilize the chlorothalonil particles in the suspension. Compounds of formula (III) may also have this ability but the stabilization ability will depend solely on the hydrophilic and hydrophobic properties of R1 and R2. In order to obtain RAFT agents of formula (I) wherein n is not 0, compounds of formula (III) are reacted with appropriate ethylenically unsaturated monomers as defined above. The conditions for preparing RAFT agents of formula (I) from compounds of formula (III) are known by the skilled person, e.g. typical conditions can be found in WO2006/037161 and WO2007/112503.

In a second aspect, as embodiment 15, there is provided a process for preparing polymer coated chlorothalonil particles according to any one of embodiments 1 to 14 comprising:

forming an aqueous suspension comprising chlorothalonil particles, a RAFT agent, one or more ethylenically unsaturated monomers;

polymerizing the one or more ethylenically unsaturated monomers under the control of the RAFT agent to thereby form a polymer coating on the surface of the chlorothalonil particle.

In embodiment 15.1, there is provided the process according to embodiment 15 wherein the RAFT agent is as defined in any one of embodiments 2 to 14.

In embodiment 15.2, there is provided the process according to embodiment 15 or 15.1 wherein the polymerization the one or more ethylenically unsaturated monomers under the control of the RAFT agent comprises the continuous addition of the ethylenically unsaturated monomers.

Typical process conditions for preparing the coated chlorothalonil particles are disclosed in WO2006/037161 and WO2007/112503.

The polymerization will usually require initiation from a source of free radicals. The source of initiating free radicals can be provided by any suitable method of generating free radicals, such as the thermally induced hemolytic scission of suitable compound(s) (thermal initiators such as peroxides, peroxyesters, or azo compounds), the spontaneous generation from monomers (e.g. styrene), redox initiating systems, photochemical initiating systems or high energy radiation such as electron beam, X- or gamma radiation. The initiating system is chosen such that under the reaction conditions there is no substantial adverse interaction of the initiator or the initiating radicals with the amphipathic RAFT agent under the conditions of the reaction.

Preferably, in embodiment 16, there is provided a process according to embodiment 15, wherein the polymerization of the one or more ethylenically unsaturated monomers under the control of the RAFT agent is initiated by adding a suitable radical initiator.

In embodiment 17, there is provided a process according to embodiment 16, wherein the radical initiator is selected from 2,2′-azobis(isobutyronitrile), 2,2′-azobis(2-cyanobutane), dimethyl 2,2′-azobis(isobutyrate), 4,4′-azobis(4-cyanovaleric acid), 2,2′-azobis(2-methylpropionitrile), 1,1′-azobis(cyclohexanecarbonitrile), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N, N′-dimethyleneisobutyramidine dihydrochloride, 2,2′-azobis(2-midinopropane)dihydrochloride, 2,2′-azobis(N, N′-dimethyleneisobutyramidine), 2,2′-azobis{2-methyl-N-[1,1-bis(hydroxymethyl)-2-hydroxyethyl]propionamide}, 2,2′-azobis{2-methyl-N[1,1-bis(hydroxymethyl)-2-ethyl]propionamide}, 2,2′-azobis[2-methyl-N-(2-hydroxyethyl)propionamide], 2,2′-azobis(isobutyramide)dihydrate, 2,2′-azobis(2,2,4-trimethylpentane), 2,2′-azobis(2-methylpropane), t-butyl peroxyacetate, t-butyl peroxybenzoate, t-butyl peroxyneodecanoate, t-butyl peroxyisobutyrate, t-butyl peroxypivalate, t-amyl peroxypivalate, diisopropylperoxydicarbonate, dicyclohexyl peroxydicarbonate, dicumyl peroxide, dibenzoyl peroxide, dilauroyl peroxide, potassium peroxydisulfate, ammonium peroxydisulfate, di-t-butyl hyponitrite and dicumyl hyponitrite.

More preferably, in embodiment 18, there is provided a process according to embodiment 16, wherein the radical initiator is 4,4′-azobis(4-cyanovaleric acid).

In another embodiment 19, there is provided a process according to any one of embodiments 15 to 18, further comprising reducing the size of the chlorothalonil particles before the addition of monomers so as to obtain a number average particle size distribution of the chlorothalonil particles of between 10 nm and 100 μm, preferably between 100nm and 10 μm, more preferably between 1 μm and 3 μm.

A skilled person will appreciate that there are different size reduction methods available for achieving the desired chlorothalonil particles size distribution such as, but not limited to, bead milling, basket-milling, triple-roll milling or ultrasonication.

In embodiment 20, there is provided a process according to any one of embodiments 15 to 19, wherein the concentration of chlorothalonil particles in the aqueous suspension is between 1-60 weight %, preferably between 30-60 weight %, most preferably 50-60 weight %.

In embodiment 21, there is provided a process according to any one of embodiments 15 to 20, wherein the pH of the aqueous suspension is in the range of 2-14, preferably in the range of 4-8, more preferably in the range of 5 and 7.

The temperature used in the process according to any one of embodiments 15 to 21 depends on the radical initiator being employed. In general, the process may be carried out in the range of 5° C. below and 20° C. above the temperature at which the radical initiator has a 10 hour half-life in water. A skilled person is well aware of the temperature at which the radical initiator has a 10 hour half-life in water or would be able to determine that temperature. Thus, in embodiment 21.1, there is provided a process according to any one of embodiments 15 to 21, wherein the temperature of the aqueous suspension is in the range of 5° C. below and 20° C. above the temperature at which the radical initiator has a 10 hour half-life in water, preferably the aqueous suspension is in the range of 0° C. and 5° C. above the temperature at which the radical initiator has a 10 hour half-life in water.

In embodiment 21.2, there is provided a process according to any one of embodiments 15 to 21, wherein the one or more ethylenically unsaturated monomers are as defined in embodiment 6.1 or 6.2. Preferably, the one or more ethylenically unsaturated monomers are selected from acrylic acid, n-butyl acrylate, 2-sulfoethyl methacrylate and methyl methacrylate. More preferably, the one or more ethylenically unsaturated monomers are selected from n-butyl acrylate and methyl methacrylate.

There is provided, in a third aspect, as embodiment 22, a coated chlorothalonil particle obtainable according to the processes defined in any one of embodiments 15 to 21.

The term “coated” or “coating” as used herein means that the polymer substantially surrounds the entire chlorothalonil particle. However, the polymer may exhibit a degree of porosity, i.e. have some holes or voids in it at some scale.

According to fourth aspect of the invention, as embodiment 23, there is provided an agrochemical composition comprising a fungicidally effective amount of a coated chlorothalonil particle according to any one of embodiments 1 to 14 and 22. In embodiment 24, there is provided an agrochemical composition according to embodiment 23 further comprising at least one additional active ingredient and/or an agrochemically-acceptable diluent or carrier. In embodiment 24.1, there is provided an agrochemical composition comprising a fungicidally effective amount of a coated chlorothalonil particle according to any one of embodiments 1 to 14 and 22, at least one additional active ingredient and an agrochemically-acceptable diluent or carrier, wherein the additional active ingredient is selected from a pesticide such as insecticide, nematicide, acaricide, fungicide, herbicide or plant growth regulator. In embodiment 24.2, there is provided an agrochemical composition according to embodiment 24.1 wherein the additional active ingredient is selected from acycloamino acid fungicides, aliphatic nitrogen fungicides, amide fungicides, anilide fungicides, antibiotic fungicides, aromatic fungicides, arsenical fungicides, aryl phenyl ketone fungicides, benzamide fungicides, benzanilide fungicides, benzimidazole fungicides, benzothiazole fungicides, botanical fungicides, bridged diphenyl fungicides, carbamate fungicides, carbanilate fungicides, conazole fungicides, copper fungicides, dicarboximide fungicides, dinitrophenol fungicides, dithiocarbamate fungicides, dithiolane fungicides, furamide fungicides, furanilide fungicides, hydrazide fungicides, imidazole fungicides, mercury fungicides, morpholine fungicides, organophosphorous fungicides, organotin fungicides, oxathiin fungicides, oxazole fungicides, phenylsulfamide fungicides, polysulfide fungicides, pyrazole fungicides, pyridine fungicides, pyrimidine fungicides, pyrrole fungicides, quaternary ammonium fungicides, quinoline fungicides, quinone fungicides, quinoxaline fungicides, strobilurin fungicides, sulfonanilide fungicides, thiadiazole fungicides, thiazole fungicides, thiazolidine fungicides, thiocarbamate fungicides, thiophene fungicides, triazine fungicides, triazole fungicides, triazolopyrimidine fungicides, urea fungicides, valinamide fungicides, and zinc fungicides. In embodiment 24.3, there is provided an agrochemical composition according to embodiment 24.1 wherein the additional active ingredient is selected from 3-difluoromethyl-1-methyl-1H-pyrazole-4-carboxylic acid (9-dichloromethylene-1,2,3,4-tetrahydro-1,4-methano-naphthalen-5-yl)-amide, 3-difluoromethyl-1-methyl-1H-pyrazole-4-carboxylic acid methoxy-[1-methyl-2-(2,4,6-trichlorophenyl)-ethyl]-amide, 1-methyl-3-difluoromethyl-1H-pyrazole-4-carboxylic acid (2-dichloromethylene-3-ethyl-1-methyl-indan-4-yl)-amide (1072957-71-1), 1-methyl-3-difluoromethyl-1H-pyrazole-4-carboxylic acid (4′-methylsulfanyl-biphenyl-2-yl)-amide, 1-methyl-3-difluoromethyl-4H-pyrazole-4-carboxylic acid [2-(2,4-dichloro-phenyl)-2-methoxy-1-methyl-ethyl]-amide, (5-Chloro-2,4-dimethyl-pyridin-3-yl)-(2,3,4-trimethoxy-6-methyl-phenyl)-methanone, (5-Bromo-4-chloro-2-methoxy-pyridin-3-yl)-(2,3,4-trimethoxy-6-methyl-phenyl)-methanone, 2-{2-[(E)-3-(2,6-Dichloro-phenyl)-1-methyl-prop-2-en-(E)-ylideneaminooxymethyl]-phenyl}-2-[(Z)-methoxyimino]-N-methyl-acetamide, 3-[-5-(4-Chloro-phenyl)-2,3-dimethyl-isoxazolidin-3-y]-pyridine, (E)-N-methyl-2-[2-(2,5-dimethylphenoxymethyl) phenyl]-2-methoxy-iminoacetamide, 4-bromo-2-cyano-N, N-dimethyl-6-trifluoromethylbenzimidazole-1-sulphonamide, a-[N-(3-chloro-2,6-xylyl)-2-methoxyacetamido]-y-butyrolactone, 4-chloro-2-cyano-N, -dimethyl-5-p-tolylimidazole-1-sulfonamide, N-allyl-4,5,-dimethyl-2-trimethylsilylthiophene-3-carboxamide, N-(I-cyano-1,2-dimethylpropyl)-2-(2,4-dichlorophenoxy) propionamide, N-(2-methoxy-5-pyridyl)-cyclopropane carboxamide, (.+−.)-cis-1-(4-chlorophenyl)-2-(1H-1,2,4-triazol-1-yl)-cycloheptanol, 2-(1-tert-butyl)-1-(2-chlorophenyl)-3-(1,2,4-triazol-1-yl)-propan-2-ol, 2′,6′-dibromo-2-methyl-4-trifluoromethoxy-4′-trifluoromethyl-1,3-thiazole-5-carboxanilide, 1-imidazolyl-1-(4′-chlorophenoxy)-3,3-dimethylbutan-2-one, methyl (E)-2-[2-[6-(2-cyanophenoxy)pyrimidin-4-yloxy]phenylp-methoxyacrylate, methyl (E)-2-[2-[6-(2-thioamidophenoxy)pyrimidin-4-yloxy]phenyl]-3-methoxyacrylate, methyl (E)-2-[2-[6-(2-fluorophenoxy)pyrimidin-4-yloxy]phenyl]-3-methoxyacrylate, methyl (E)-2-[2-[6-(2,6-difluorophenoxy)pyrimidin-4-yloxy]phenyl]-3-methoxyacrylate, methyl (E)-2-[2-3-(pyrimidin-2-yloxy)phenoxy]phenyl]-3-methoxyacrylate, methyl (E)-2-[2-[3-(5-methylpyrimidin-2-yloxy)-phenoxy]phenyl]-3-methoxyacrylate, methyl (E)-2-[2-3-(phenyl-sulphonyloxy)phenoxy]phenyl-3-methoxyacrylate, methyl (E)-2-[2-[3-(4-nitrophenoxy)phenoxy]phenyl]-3-methoxyacrylate, methyl (E)-2-[2-phenoxyphenyl]-3-methoxyacrylate, methyl (E)-2-[2-(3,5-dimethyl-benzoyl)pyrrol-1-yl]-3-methoxyacrylate, methyl (E)-2-[2-(3-methoxyphenoxy)phenyl]-3-methoxyacrylate, methyl (E)-2-[2-(2-phenylethen-1-yl)-phenyl]-3-methoxyacrylate, methyl (E)-2-[2-(3,5-dichlorophenoxy)pyridin-3-yl]-3-methoxyacrylate, methyl (E)-2-(2-(3-(1,1,2,2-tetrafluoroethoxy)phenoxy)phenyl)-3-methoxyacrylate, methyl (E)-2-(2-[3-(alpha-hydroxybenzyl)phenoxy]phenyl)-3-methoxyacrylate, methyl (E)-2-(2-(4-phenoxypyridin-2-yloxy)phenyl)-3-methoxyacrylate, methyl (E)-2-[2-(3-n-propyloxy-phenoxy)phenyl]3-methoxyacrylate, methyl (E)-2-[2-(3-isopropyloxyphenoxy)phenyl]-3-methoxyacrylate, methyl (E)-2-[2-[3-(2-fluorophenoxy)phenoxy]phenyl]-3-methoxyacrylate, methyl (E)-2-[2-(3-ethoxyphenoxy)phenyl]-3-methoxyacrylate, methyl (E)-2-[2-(4-tert-butyl-pyridin-2-yloxy)phenyl]-3-methoxyacrylate, methyl (E)-2-[2-[3-(3-cyanophenoxy)phenoxy]phenyl]-3-methoxyacrylate, methyl (E)-2-[2-[(3-methyl-pyridin-2-yloxymethyl)phenyl]-3-methoxyacrylate, methyl (E)-2-[2-[6-(2-methyl-phenoxy)pyrimidin-4-yloxy]phenyl]-3-methoxyacrylate, methyl (E)-2-[2-(5-bromo-pyridin-2-yloxymethyl)phenyl]-3-methoxyacrylate, methyl (E)-2-[2-(3-(3-iodopyridin-2-yloxy)phenoxy)phenyl]-3-methoxyacrylate, methyl (E)-2-[2-[6-(2-chloropyridin-3-yloxy)pyrimidin-4-yloxy]phenyl]-3-methoxyacrylate, methyl (E),(E)-2-[2-(5,6-dimethylpyrazin-2-ylmethyloximinomethyl)phenyl]-3-methoxyacrylate, methyl (E)-2-{2-[6-(6-methylpyridin-2-yloxy)pyrimidin-4-yloxy]phenyl}-3-methoxy-acrylate, methyl (E),(E)-2-{2-(3-methoxyphenyl)methyloximinomethyl]-phenyl}-3-methoxyacrylate, methyl (E)-2-[2-(6-(2-azidophenoxy)-pyrimidin-4-yloxy]phenyl}-3-methoxyacrylate, methyl (E),(E)-2-{2-[6-phenylpyrimidin-4-yl)-methyloximinomethyl]phenyl}-3-methoxyacrylate, methyl (E),(E)-2-{2-[(4-chlorophenyl)-methyloximinomethyl]-phenyl}-3-methoxyacryl ate, methyl (E)-2-{2-[6-(2-n-propylphenoxy)-1,3,5-triazin-4-yloxy]phenyl}-3-methoxyacrylate, methyl (E),(E)-2-{2-[(3-nitrophenyl)methyloximinomethyl]phenyl}-3-methoxyacrylate, 3-chloro-7-(2-aza-2,7,7-trimethyl-oct-3-en-5-ine), 2,6-dichloro-N-(4-trifluoromethylbenzyl)-benzamide, 3-iodo-2-propinyl alcohol, 4-chlorophenyl-3-iodopropargyl formal, 3-bromo-2,3-diiodo-2-propenyl ethylcarbamate, 2,3,3-triiodoallyl alcohol, 3-bromo-2,3-diiodo-2-propenyl alcohol, 3-iodo-2-propinyl n-butylcarbamate, 3-iodo-2-propinyl n-hexylcarbamate, 3-iodo-2-propinyl cyclohexyl-carbamate, 3-iodo-2-propinyl phenylcarbamate; phenol derivatives, such as tribromophenol, tetrachlorophenol, 3-methyl-4-chlorophenol, 3,5-dimethyl-4-chlorophenol, phenoxyethanol, dichlorophene, o-phenylphenol, m-phenylphenol, p-phenylphenol, 2-benzyl-4-chlorophenol, 5-hydroxy-2(5H)-furanone; 4,5-dichlorodithiazolinone, 4,5-benzodithiazolinone, 4,5-trimethylenedithiazolinone, 4,5-dichloro-(3H)-1,2-dithiol-3-one, 3,5-dimethyl-tetrahydro-1,3,5-thiadiazine-2-thione, N-(2-p-chlorobenzoylethyl)-hexaminium chloride, acibenzolar, acypetacs, adepydin, alanycarb, albendazole, aldimorph, allicin, allyl alcohol, ametoctradin, amisulbrom, amobam, ampropylfos, anilazine, asomate, aureofungin, azaconazole, azafendin, azithiram, azoxystrobin, barium polysulfide, benalaxyl, benalaxyl-M, benodanil, benomyl, benquinox, bentaluron, benthiavalicarb, benthiazole, benzalkonium chloride, benzamacril, benzamorf, benzohydroxamic acid, benzovindiflupyr, berberine, bethoxazin, biloxazol, binapacryl, biphenyl, bitertanol, bithionol, bixafen, blasticidin-S, boscalid, bromothalonil, bromuconazole, bupirimate, buthiobate, butylamine calcium polysulfide, captafol, captan, carbamorph, carbendazim, carbendazim chlorhydrate, carboxin, carpropamid, carvone, CGA41396, CGA41397, chinomethionate, chitosan, chlobenthiazone, chloraniformethan, chloranil, chlorfenazole, chloroneb, chloropicrin, chlorothalonil, chlorozolinate, chlozolinate, climbazole, clotrimazole, clozylacon, copper containing compounds such as copper acetate, copper carbonate, copper hydroxide, copper naphthenate, copper oleate, copper oxychloride, copper oxyquinolate, copper silicate, copper sulphate, copper tallate, copper zinc chromate and Bordeaux mixture, cresol, cufraneb, cuprobam, cuprous oxide, cyazofamid, cyclafuramid, cycloheximide, cyflufenamid, cymoxanil, cypendazole, cyproconazole, cyprodinil, dazomet, debacarb, decafentin, dehydroacetic acid, di-2-pyridyl disulphide 1,1′-dioxide, dichlofluanid, diclomezine, dichlone, dicloran, dichlorophen, dichlozoline, diclobutrazol, diclocymet, diethofencarb, difenoconazole, difenzoquat, diflumetorim, O,O-di-iso-propyl-S-benzyl thiophosphate, dimefluazole, dimetachlone, dimetconazole, dimethomorph, dimethirimol, diniconazole, diniconazole-M, dinobuton, dinocap, dinocton, dinopenton, dinosulfon, dinoterbon, diphenylamine, dipyrithione, disulfiram, ditalimfos, dithianon, dithioether, dodecyl dimethyl ammonium chloride, dodemorph, dodicin, dodine, doguadine, drazoxolon, edifenphos, enestroburin, epoxiconazole, etaconazole, etem, ethaboxam, ethirimol, ethoxyquin, ethilicin, ethyl (Z)-N-benzyl-N ([methyl (methyl-thioethylideneamino-oxycarbonyl)amino]thio)-ß-alaninate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fenpyrazamine, fentin acetate, fentin hydroxide, ferbam, ferimzone, fluazinam, fludioxonil, flumetover, flumorph, flupicolide, fluopyram, fluoroimide, fluotrimazole, fluoxastrobin, fluquinconazole, flusilazole, flusulfamide, flutanil, flutolanil, flutriafol, fluxapyroxad, folpet, formaldehyde, fosetyl, fuberidazole, furalaxyl, furametpyr, furcarbanil, furconazole, furfural, furmecyclox, furophanate, glyodin, griseofulvin, guazatine, halacrinate, hexa chlorobenzene, hexachlorobutadiene, hexachlorophene, hexaconazole, hexylthiofos, hydrargaphen, hydroxyisoxazole, hymexazole, imazalil, imazalil sulphate, imibenconazole, iminoctadine, iminoctadine triacetate, inezin, iodocarb, ipconazole, ipfentrifluconazole, iprobenfos, iprodione, iprovalicarb, isopropanyl butyl carbamate, isoprothiolane, isopyrazam, isotianil, isovaledione, izopamfos, kasugamycin, kresoxim-methyl, LY186054, LY211795, LY248908, mancozeb, mandipropamid, maneb, mebenil, mecarbinzid, mefenoxam, mefentrifluconazole, mepanipyrim, mepronil, mercuric chloride, mercurous chloride, meptyldinocap, metalaxyl, metalaxyl-M, metam, metazoxolon, metconazole, methasulfocarb, methfuroxam, methyl bromide, methyl iodide, methyl isothiocyanate, metiram, metiram-zinc, metominostrobin, metrafenone, metsulfovax, milneb, moroxydine, myclobutanil, myclozolin, nabam, natamycin, neoasozin, nickel dimethyldithiocarbamate, nitrostyrene, nitrothal-iso-propyl, nuarimol, octhilinone, ofurace, organomercury compounds, orysastrobin, osthol, oxadixyl, oxasulfuron, oxathiapiprolin, oxine-copper, oxolinic acid, oxpoconazole, oxycarboxin, parinol, pefurazoate, penconazole, pencycuron, penflufen, pentachlorophenol, penthiopyrad, phenamacril, phenazin oxide, phosdiphen, phosetyl-AI, phosphorus acids, phthalide, picoxystrobin, piperalin, polycarbamate, polyoxin D, polyoxrim, polyram, probenazole, prochloraz, procymidone, propamidine, propamocarb, propiconazole, propineb, propionic acid, proquinazid, prothiocarb, prothioconazole, pydiflumetofen, pyracarbolid, pyraclostrobin, pyrametrostrobin, pyraoxystrobin, pyrazophos, pyribencarb, pyridinitril, pyrifenox, pyrimethanil, pyriofenone, pyroquilon, pyroxychlor, pyroxyfur, pyrrolnitrin, quaternary ammonium compounds, quinacetol, quinazamid, quinconazole, quinomethionate, quinoxyfen, quintozene, rabenzazole, santonin, sedaxane, silthiofam, simeconazole, sipconazole, sodium pentachlorophenate, solatenol, spiroxamine, streptomycin, sulphur, sultropen, tebuconazole, tebfloquin, tecloftalam, tecnazene, tecoram, tetraconazole, thiabendazole, thiadifluor, thicyofen, thifluzamide, 2-(thiocyanomethylthio)benzothiazole, thiophanate-methyl, thioquinox, thiram, tiadinil, timibenconazole, tioxymid, tolclofos-methyl, tolylfluanid, triadimefon, triadimenol, triamiphos, triarimol, triazbutil, triazoxide, tricyclazole, tridemorph, trifloxystrobin, triflumazole, triforine, triflumizole, triticonazole, uniconazole, urbacide, validamycin, valifenalate, vapam, vinclozolin, zarilamid, zineb, ziram, and zoxamide. In embodiment 24.4, there is provided an agrochemical composition according to embodiment 24.1 wherein the additional active ingredient is selected from azoxystrobin, difenoconazole, mandipropamid, oxathiapiprolin, mefenoxam and pydiflumetofen.

According to a fifth aspect of the invention, there is provided a method of controlling or preventing infestation of useful plants by phytopathogenic microorganisms, wherein a fungicidally effective amount of a coated chlorothalonil according to any one of embodiments 1 to 14 and 22, or a composition according to embodiment 23 or 24, is applied to the plants, to parts thereof or the locus thereof.

According to a sixth aspect of the invention, there is provided the use of a coated chlorothalonil particle according to any one of embodiments 1 to 14 and 22 as a fungicide.

According to a seventh aspect of the invention, there is provided a method for protecting plant propagation material from damage and/or yield loss caused by a pest and/or fungi which comprises applying to the propagation material or the site, where the propagation material is planted, an effective amount of coated chlorothalonil particles as defined in any one of embodiments 1 to 14 and 22 or a composition defined in either embodiment 23 or 24.

According to an eighth aspect of the invention, there is provided a method of reducing inhalation toxicity to mammals of chlorothalonil particles or compositions containing chlorothalonil particles comprising polymer coating the chlorothalonil particles under the control of a Reversible Addition-Fragmentation chain Transfer (RAFT) agent. Preferably, there is provided a method of reducing inhalation toxicity to mammals of chlorothalonil particles or compositions containing chlorothalonil particles comprising polymer coating the chlorothalonil particles according to any one of embodiments 15 to 21.

The term “coated particles according to the present invention” or “coated particle according to the present invention” means coated chlorothalonil particles according to any one of embodiments 1 to 14 or 22.

The coated chlorothalonil particles according to the present invention can be used in the agricultural sector and related fields of use, e.g., as active ingredients for controlling plant pests or on non-living materials for control of spoilage microorganisms or organisms potentially harmful to man. The novel coated particles according to the present invention are distinguished by excellent activity at low rates of application comparable with uncoated chlorothalonil and by exhibiting a much reduced inhalation toxicity to mammals.

The present invention further relates to a method for controlling or preventing infestation of plants or plant propagation material and/or harvested food crops susceptible to microbial attack by treating plants or plant propagation material and/or harvested food crops wherein an effective amount of a coated particle according to the present invention is applied to the plants, to parts thereof or the locus thereof.

There is also provided the use of coated particle according to the present invention as a fungicide. The term “fungicide” as used herein means a compound that controls, modifies, or prevents the growth of fungi. The term “fungicidally effective amount” means the quantity that is capable of producing an effect on the growth of fungi. Controlling or modifying effects include all deviation from natural development, such as killing, retardation and the like, and prevention includes barrier or other defensive formation in or on a plant to prevent fungal infection.

It is also possible to use coated particles according to the present invention as dressing agents for the treatment of plant propagation material, e.g., seed, such as fruits, tubers or grains, or plant cuttings (e.g., rice), for the protection against fungal infections, as well as against phytopathogenic fungi occurring in the soil. The propagation material can be treated with a composition comprising a coated particle according to the present invention before planting: seed, e.g., can be dressed before being sown.

The coated particles according to the present invention can also be applied to grains (coating), either by impregnating the seeds in a liquid formulation or by coating them with a solid formulation. The composition can also be applied to the planting site when the propagation material is being planted, e.g., to the seed furrow during sowing. The invention relates also to such methods of treating plant propagation material and to the plant propagation material so treated.

The term “locus” as used herein means fields in or on which plants are growing, or where seeds of cultivated plants are sown, or where seed will be placed into the soil. It includes soil, seeds, and seedlings, as well as established vegetation.

The term “plants” refers to all physical parts of a plant, including seeds, seedlings, saplings, roots, tubers, stems, stalks, foliage, and fruits.

The term “plant propagation material” is understood to denote generative parts of the plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

The coated particles according to the present invention may be used in unmodified form or, preferably, together with the adjuvants conventionally employed in the art of formulation. The compositions may also contain further adjuvants such as stabilizers, antifoams, viscosity regulators, binders or tackifiers as well as fertilizers, micronutrient donors or other formulations for obtaining special effects.

Suitable carriers and adjuvants, e.g., for agricultural use, can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

The coated particles according to the present invention are normally used in the form of compositions and can be applied to the crop area or plant to be treated, simultaneously or in succession with further compounds. These further compounds can be, e.g., fertilizers or micronutrient donors or other preparations, which influence the growth of plants. They can also be selective herbicides or non-selective herbicides as well as insecticides, fungicides, bactericides, nematicides, molluscicides or mixtures of several of these preparations, if desired together with further carriers, surfactants or application promoting adjuvants customarily employed in the art of formulation.

The coated particles according to the present invention may be used in the form of (fungicidal) compositions for controlling or protecting against phytopathogenic microorganisms, comprising as active ingredient a coated particle according to the present invention, and at least one of the above-mentioned adjuvants.

The invention provides a composition, preferably a fungicidal composition, comprising a coated particle according to the present invention, an agriculturally acceptable carrier and optionally an adjuvant. An agricultural acceptable carrier is for example a carrier that is suitable for agricultural use. Agricultural carriers are well known in the art. Preferably, said composition may comprise at least one or more pesticidally active compounds, for example an additional fungicidal active ingredient in addition to the coated particle according to the present invention.

The coated particle according to the present invention may be the sole active ingredient of a composition or it may be admixed with one or more additional active ingredients such as a pesticide, fungicide, synergist, herbicide or plant growth regulator where appropriate.

Another aspect of invention is related to the use of a coated particle according to the present invention, of a composition comprising a coated particle according to the present invention, or of a fungicidal or insecticidal mixture comprising a coated particle according to the present invention, in admixture with other fungicides or insecticides as described above, for controlling or preventing infestation of plants, e.g. useful plants such as crop plants, propagation material thereof, e.g. seeds, harvested crops, e.g., harvested food crops, or non-living materials by insects or by phytopathogenic microorganisms, preferably fungal organisms.

A further aspect of invention is related to a method of controlling or preventing an infestation of plants, e.g., useful plants such as crop plants, propagation material thereof, e.g. seeds, harvested crops, e.g. harvested food crops, or of non-living materials by insects or by phytopathogenic or spoilage microorganisms or organisms potentially harmful to man, especially fungal organisms, which comprises the application of a coated particle according to the present invention as active ingredient to the plants, to parts of the plants or to the locus thereof, to the propagation material thereof, or to any part of the non-living materials.

Controlling or preventing means reducing infestation by insects or by phytopathogenic or spoilage microorganisms or organisms potentially harmful to man, especially fungal organisms, to such a level that an improvement is demonstrated.

A preferred method of controlling or preventing an infestation of crop plants by phytopathogenic microorganisms, especially fungal organisms, or insects which comprises the application of a coated particle according to the present invention, or an agrochemical composition which contains a coated particle according to the present invention, is foliar application. The frequency of application and the rate of application will depend on the risk of infestation by the corresponding pathogen or insect. However, the coated particles according to the present invention may also penetrate the plant through the roots via the soil (systemic action) by drenching the locus of the plant with a liquid formulation, or by applying the compounds in solid form to the soil, e.g., in granular form (soil application). In crops of water rice such granulates can be applied to the flooded rice field. The coated particles according to the present invention may also be applied to seeds (coating) by impregnating the seeds or tubers either with a liquid formulation of the fungicide or coating them with a solid formulation.

A formulation, e.g. a composition containing the coated particle according to the present invention, and, if desired, a solid or liquid adjuvant, may be prepared in a known manner, typically by intimately mixing and/or grinding the compound with extenders, for example solvents, solid carriers and, optionally, surface active compounds (surfactants).

Advantageous rates of application are normally from 5 g to 2 kg of active ingredient (a.i.) per hectare (ha), preferably from 10 g to 1 kg a.i./ha, most preferably from 20 g to 600 g a.i./ha. When used as seed drenching agent, convenient dosages are from 10 mg to 1 g of active substance per kg of seeds.

When the compositions of the present invention are used for treating seed, rates of 0.001 to 50 g of a coated particle according to the present invention per kg of seed, preferably from 0.01 to 10 g per kg of seed are generally sufficient.

The compositions of the invention may be employed in any conventional form, for example in the form of a twin pack, a powder for dry seed treatment (DS), a flowable concentrate for seed treatment (FS), a water dispersible powder for seed treatment (WS), a suspension concentrate (SC), a water dispersible granule (WG), an emulsifiable granule (EG), a wettable powder (WP) or any technically feasible formulation in combination with agriculturally acceptable adjuvants.

Such compositions may be produced in conventional manner, e.g. by mixing the active ingredients with appropriate formulation inerts (diluents, solvents, fillers and optionally other formulating ingredients such as surfactants, biocides, anti-freeze, stickers, thickeners and compounds that provide adjuvancy effects).

A seed dressing formulation is applied in a manner known per se to the seeds employing the combination of the invention and a diluent in suitable seed dressing formulation form, e.g., as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least the coated particle according to the present invention together with component (B) and (C), and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

Experimental

Preparation of Coated Chlorothalonil

(a) Preparation of intermediate 1: (2-{[(butylsulfanyl)carbonothioyl]sulfanyl}propanoic acid)-((butyl acrylate)ₘ-co-(acrylic acid)ₓ-co-(2-sulfoethyl methacrylate)_{y}), and wherein the target average degree of polymerization is m≈8, x≈5 and y≈5.

The reaction was carried out in a jacketed 5 litre vessel reaction rig with overhead stirring (200 rpm (round per minute) pitch blade stirrer) and baffles.

2-Sulfoethyl methacrylate (584.51 g, 3.01 mol) was dissolved into 1,4-dioxane (500 g) in a 2 L holding tank. Subsequently, acrylic acid (217.01 g, 3.01 mol) and n-butyl acrylate (617.55 g, 4.818 mol) were added with stirring.

In the reaction vessel, 2-{[(butylsulfanyl)carbonothioyl]sulfanyl}propanoic acid (144.79 g, 0.68 mol) and 4,4′-azobis(4-cyanovaleric acid) (11.14 g, 0.0397 mol) were dissolved into 1,4-dioxane (2750 g). The reaction vessel was deoxygenated by bubbling with nitrogen for 45 minutes with stirring. The reaction vessel and the holding tank remained under positive nitrogen pressure for the reaction. The reaction vessel was sealed other than the N₂ inlet. The reaction was run at 70° C. and stirred at 200 rpm with a pitch-blade stirrer head. The deoxygenated monomers were fed into the reactor at 5 mL/minute (6.92 h) using a syringe pump, and left to react for 1 hour after all monomer had been added to the reaction vessel. To end the reaction, the vessel was cooled to room temperature with stirring.

Subsequently, the reaction solution was measured by ¹H-NMR to see the disappearance of acrylate and methacrylate protons at 4.5-5.5 ppm, and by gel permeation chromatography, using DMF as the eluent, to check that a narrow dispersity, “living” polymerization had occurred. After checking that the monomer and initiator was consumed, the reaction solution was transferred to a round bottom flask and the 1,4-dioxane removed under reduced pressure to yield a viscous orange product (intermediate 1).

(b) Chlorothalonil Particle Preparation

Water (40.719 kg) was added to a water cooled jacketed vessel. A solution of intermediate 1 (2372 g) was added under low-shear mixing, followed by sodium hydroxide solution (246 g, 3.56 mol). The pH of the solution was recorded at 6.7. Chlorothalonil (56.7 kg) was then added under high sheer mixing, and the contents subjected to high-shear mixing using a grinding head until a particle size suitable for bead-milling was achieved. The mixture was then bead-milled to a number average particle size distribution of 2.2 μm, measured on a Malvern Mastersizer 2000, with a particle refractive index of 1.6 and absorption of 0.01, to give a white/grey suspended mixture 1. Microscopy revealed an overwhelming proportion of individually dispersed particles, with occasional small groups of particles agglomerated together.

(c) Coating of Chlorothalonil Particles

Suspended mixture 1 (6.298 kg) and 4,4′-azobis(4-cyanovaleric acid) (10.4 g) were added to a vessel equipped with overhead stirring, and deoxygenated by sparging with nitrogen gas and heated to 70° C.

Deoxygenated monomers methyl methacrylate (126.4 g) and n-butyl acrylate (12.6 g) were fed into the reaction vessel over the course of 2 hours, and left to react for a further 1 hour.

(d) Characterisation of Coated Chlorothalonil Particles:

The particle size distribution after coating and sieving was found to have a number average particle size distribution of 2.1 μm, and was comparable to that of the millbase before coating.

Light microscopy of the product showed almost entirely individually dispersed particles.

The coated millbase was analysed by gas chromatography to indirectly determine the mass of polymer that was bound to the particle surface. This was done by centrifuging a 2 ml sample at 5000 rpm for 10 minutes, and removing the clear upper layer that was produced. This was replaced with deionized water, the sample homogenized, and the process carried out twice more. The sample was then allowed to dry in a petri dish, after which it was ground to a fine powder using a pestle and mortar.

After a further 24 h drying at 100° C. in a vacuum oven, the powder was analysed for chlorothalonil content. This process was carried out for 3 separate subsamples, the average result from which was 95.96% by mass. The millbase before coating was found to be 99.04% by the same procedure, showing that an additional 2.3 g of polymer per 100 g of chlorothalonil was bound to the surface of the particles after the coating reaction. The chlorothalonil purity was also taken into account in this analysis.

It is understood that the amount of monomers can be varied in order to change the amount of polymer per 100 g of chlorothalonil. The following coated chlorothalonil particles were prepared:

| | Weight % surface polymer on |
|---|---|
| | chlorothalonil particles as of the total |
| Coated chlorothalonil particle | weight of coated chlorothalonil particles |
| A1 | 2.3 |
| A2 | 5.4 |
| A3 | 11.0 |

Preparation of Formulations:

The following abbreviations are used for the formulations containing the coated chlorothalonil particles A1, A2, and A3:

Chlorothalonil coated particle

| | A1 | A2 | A3 |
|---|---|---|---|
| Formulation | F1 | F2 | F3 |

Recipe used for formulations F1, F2 and F3:

| Component | Mass (g) |
|---|---|
| Polymer-coated | 5251 |
| chlorothalonil millbase | |
| (A1, A2 and A3) | |
| Xanthan gum | 12.1 |
| (Rhodopol 23 ®) | |
| Montmorillonite clay | 121 |
| (Bentopharm B20 ®) | |
| 1,2-benzisothiazol-3-one | 18.0 |
| (Proxel GXL ®) | |
| poly[1-(2-oxo-1-pyrrolidinyl)ethylene] | 28.2 |
| (Luvitec K30 ®) | |
| Polydimethylsiloxane | 8.2 |
| (Antifoam MSA ®) | |
| Water | 4004 |

The formulation for uncoated chlorothalonil particles was prepared in a similar manner using a standard block co-polymer.

Procedure:

Water was added to a 10 L stainless steel jacketed vessel under cooling. Under high-shear mixing the Rhodopol 23®, Bentopharm B20®, Antifoam MSA®, Proxel GXL® and Luvitec K30® were added, and the mixture mixed for 30 minutes. The cooling was then removed, and under low-shear mixing the coated chlorothalonil millbase was added. Low-shear mixing was maintained for a further 30 minutes.

Biological Data

a) Inhalation Toxicity Studies:

The acute inhalation toxicity of the chlorothalonil formulations was assessed according to the OECD Test Guidelines 403 (TG 403), an internationally recognized test method. These guidelines are widely available, e.g. they can be found on http://www.keepeek.com/Digital-Asset-Management/oecd/environment/test-no-403-acute-inhalation-toxicity_9789264070608-en#.WD_tTE2Qy70.

TABLE 1
Comparison of acute inhalation toxicity outcomes with chlorothalonil
formulations with different amounts of RAFT coating at similar
atmosphere concentrations (mg/l) tested on rats (both sexes):

| | Sample | Atmosphere | | |
|---|---|---|---|---|
| | chlorothalonil | concentration | | Estimated |
| | concentration | of sample | | classification |
| Formulation | (g/l) | (mg/L) | Mortality | under GHS* |
| Uncoated chlorothalonil | 350 | 0.74 | 30% | H331 Toxic if Inhaled |
| | | 1.35 | 60% | |
| F1 | 350 | 0.45 | 0% | H332 Harmful if inhaled |
| | | 1.04 | 10% | |
| | | 1.42 | 20% | |
| F2 | 350 | 0.43 | 0% | H332 Harmful if inhaled |
| | | 1.04 | 0% | |
| | | 1.51 | 20% | |
| F3 | 350 | 0.83 | 0% | No Classification |
| | | 1.45 | 0% | |
| | | 2.11 | 0% | |

*Globally Harmonzied System of Classification and Labelling of Chemicals

Conclusion:

Chlorothalonil particles coated according to the invention are associated with an improved acute inhalation toxicity profile, with a marked improvement observed with coatings of 2.3% and above.

b) Control of Zymoseptoria tritici Infection of Wheat:

Objective:

Comparing 2 formulations of chlorothalonil particles according to the invention

Assessing Zymoseptoria tritici control on wheat plants grown under semifield conditions: outside grown plants, but infection timing is controlled

Comparing short and long preventive timing of application

Plants:

Wheat variety Akteur, transplanted into pots (15×15 cm), 2 plants per pot, containing local soil, from field grown plants in spring (wheat was planted in the previous autumn in a regular field, transplanted in March). Plants were cleaned from initial septoria and rust infections with one initial fungicide treatment shortly after potting. Potted plants are maintained in a poly-tunnel. This poly-tunnel has an option for open roof and side panels allowing normal sun and wind exposure to ensure field like physiology of plants. Roof and side panels were closed during rain to prevent any unintentional natural infection of plants by Zymoseptoria tritici. Plants are grown under no-rain conditions until infection with Zymoseptoria tritici.

Several maintenance sprays to control infection by powdery mildew and insects were used avoiding any septoria leaf blotch active compounds.

Application:

Application was done with a specialized boom-sprayer developed for small plot field trials as follows:

Volume: 500 l/ha

Pressure: 4 bar

Hight: 50 cm over targetleaf

Nozzle type: Turbo Teejet 110-01

Speed: 1.25 Km/h

Plant growth stage: BBCH 37, target leaf is F2

Infection:

Application of a Zymoseptoria tritici conidiospore suspension (1.5 Mio spores/ml) in water supplemented with 0.1% Tween 20® using a Petrol Back Pack Mistblower, followed by 48 h under a tent with regular misting (resulting in wet leaves and constant high humidity). Independent infection was done on two different sets of plants. One set was treated and infected such as to result in a 3 days preventive treatment, the other set of plants had a 10 days preventive treatment. After the tent was removed, the poly-tunnel was left open, the plants exposed to natural rain events.

Trial Design:

For each application timing, each active treatment was applied to 4 pots of wheat and 12 pots were left as untreated checks. Pots of different treatments were then completely randomized within each infection timing. Per pot, up to 4 target leaves were evaluated.

Evaluation.

Disease severity was evaluated by assessing % coverage of the target leaf with Zymosepteria tritici blotch symptoms. Evaluation was done when untreated plants showed a disease coverage of ca. 40-50% on the target leaf.

Analysis:

For each application timing, the four measurements from each pot were averaged and then subjected to an analysis of variance to compare the treatments. The efficacy of each treatment was estimated as follows:

Control=100*(A−B)/A

where A is the mean disease coverage of untreated, and B is the mean disease coverage for each treatment.

Results:

The following Table 2 shows the mean % Disease Cover and estimated % Control for each treatment for each of the application timings.

TABLE 2

| | | % Disease Cover | | | |
|---|---|---|---|---|---|
| | | 3 Day | | 10 Day | |
| | | Preventative 25 DPI | | Preventative 21 DPI | |
| | | | % | | % |
| Treatment | Rate (g/ha) | Mean | Control | Mean | Control |
| Untreated | 750 | 49.8 | | 41.1 | |
| F1 | 750 | 13.3 | 73 | 12.5 | 70 |
| F2 | 750 | 24.4 | 51 | 18.8 | 54 |

It will be understood that the invention disclosed and defined in this specification extends to all alternative combinations of two or more of the individual features mentioned or evident from the text or drawings. All of these different combinations constitute various alternative aspects of the invention.

1. A coated chlorothalonil particle comprising
a chlorothalonil particle, and
a polymer coating on the surface of the chlorothalonil particle,
wherein the polymer coating comprises a Reversible Addition-Fragmentation chain Transfer (RAFT) agent.

2. The coated chlorothalonil particle according to claim 1, wherein the RAFT agent is of formula (I) 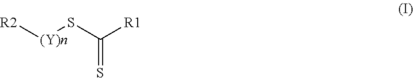
wherein
each Y is independently selected from a polymerized residue of an ethylenically unsaturated monomer;
n is an integer ranging from 0 to 100;
R1 is selected from C₁₋₂₀ alkyl, C₁₋₂₀ alkoxy, aryloxy, aryl, aryl C₁₋₂₀ alkyl, heterocyclyl, heterocyclyl C₁₋₂₀ alkyl, C₁₋₂₀ alkyl heterocyclyl, C₁₋₂₀ alkyl aryl, C₁₋₂₀ alkylthio, aryl C₁₋₂₀ alkylthio, —P(═O)(OC₁₋₂₀ alkyl)₂, —P(═O)(C₁₋₂₀ alkyl)₂, —C(═O)NH₂, —C(═O)(C(═NH)R^{1a}) and —NR^{1a}R^{1b}, wherein R^{1a} and R^{1b} are C₁₋₂₀ alkyl, or R^{1a} and R^{1b} together with the N atom to which they are attached form a heterocyclyl ring, and wherein each R1 is unsubstituted or substituted with a substituent independently selected from —C(═O)OH, —SO₃H, —OSO₃H, —OP(OH)₂, —P(OH)₂, —PO(OH)₂, —OH, ═O, —CONH₂, —CONHR′, —CONR′R″, —NR′R″ and —N⁺R′R″R′″;
R2 is selected from C₁₋₆ alkyl, C₁₋₆ alkoxy aryl or heteroaryl, each of which is substituted with one or more substituent independently selected from —C(═O)OH, —CN, —C(═O)OR′, —C(═O)OR^{2a}NR′R″, —SOR^{2a}NR′R″, —SO₂R^{2a}NR′R″, —SO₃H, —OSO₃H, —OP(OH)₂, —P(OH)₂, —PO(OH)₂, —OH, —OR^{2a}NR′R″, —(OCH₂—CHR′)_{w}—OH, —CONH₂, —CONHR′, —CONR′R″, —NR′R″ and —N⁺R′R″R′″;
R^{2a} is C₁₋₆ alkyl;
w is an integer ranging from 1 to 10;
R′, R″ and R′″ are each independently C₁₋₆ alkyl which is unsubstituted or substituted with one or more hydrophilic substituents, preferably independently selected from —C(═O)OH, —SO₃H, —OSO₃H, —OP(OH)₂, —P(OH)₂, —PO(OH)₂, —OH and —CONH₂.

3. The coated chlorothalonil particle according to claim 1, wherein
R1 is selected from C₁₋₂₀ alkyl, aryl C₁₋₂₀ alkyl, C₁₋₂₀ alkylthio, aryl C₁₋₂₀ alkylthio and —NR^{1a}R^{1b}, wherein R^{1a} and R^{1b} are C₁₋₂₀ alkyl, or R^{1a} and R^{1b} together with the N atom to which they are attached form a heterocyclyl ring, and wherein each R1 is unsubstituted or substituted with a substituent independently selected from —C(═O)OH, —SO₃H, —OSO₃H, —OP(OH)₂, —P(OH)₂, —PO(OH)₂, —OH, —CONH₂, —CONHR′, —CONR′R″, —NR′R″ and —N⁺R′R″R′″;
R2 is selected from C₁₋₆ alkyl, C₁₋₆ alkoxy aryl or heteroaryl, each of which is substituted with one or more substituent independently selected from —C(═O)OH, —CONH₂, —CONHR′, —CN and —CONR′R″;
R′, R″ and R′″ are independently C₁₋₆ alkyl which is unsubstituted or substituted with one or more hydrophilic substituents, preferably independently selected from —C(═O)OH, —SO₃H, —OSO₃H, —OP(OH)₂, —P(OH)₂, —PO(OH)₂, —OH and —CONH₂.

4. The coated chlorothalonil particle according to claim 3, wherein
R1 is selected from C₁₋₁₀ alkyl and C₁₋₁₀ alkylthio, wherein each R1 is unsubstituted or substituted with a substituent independently selected from —C(═O)OH, —SO₃H, —OSO₃H, —OP(OH)₂, —P(OH)₂, —PO(OH)₂, —OH, —CONH₂, —CONHR′, —CONR′R″, —NR′R″ and —N⁺R′R″R′″;
R2 is selected from C₁₋₆ alkyl, each of which is substituted with one or more substituent independently selected from —C(═O)OH, —CN and —CONH₂;
R′, R″ and R′″ are independently C₁₋₆ alkyl which is unsubstituted or substituted with one or more hydrophilic substituents, preferably independently selected from —C(═O)OH, —SO₃H, —OSO₃H, —OP(OH)₂, —P(OH)₂, —PO(OH)₂, —OH and —CONH₂.

5. The coated chlorothalonil particle according to claim 1, wherein the RAFT agent is of formula (Ia) 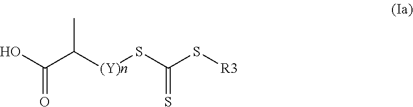
wherein
R3 is C₁₋₆ alkyl which is unsubstituted or substituted with one or more (hydrophilic) substituents independently selected from —C(═O)OH, —SO₃H, —OSO₃H, —OP(OH)₂, —P(OH)₂, —PO(OH)₂, —OH, —CONH₂, —CONHR′, —CONR′R″, —NR′R″ and —N⁺R′R″R′″;
R′, R″ and R′″ are C₁₋₆ alkyl which is unsubstituted or substituted with one or more (hydrophilic) substituents independently selected from —C(═O)OH, —SO₃H, —OSO₃H, —OP(OH)₂, —P(OH)₂, —PO(OH)₂, —OH, —CONH₂;
each Y is a polymerized residue of an ethylenically unsaturated monomer independently selected from methyl methacrylate, ethyl methacrylate, propyl methacrylate, butyl methyacrylate, 2-ethyl-hexyl methacrylate, isobornyl methacrylate, methacrylic acid, benzyl methacrylate, phenyl methacrylate, methyl acrylate, ethyl acrylate, propyl acrylate, butyl acrylate, 2-ethyl-hexyl acrylate, isobornyl acrylate, acrylic acid, benzyl acrylate, phenyl acrylate, sulfomethyl methacrylate, sulfoethyl methacrylate, sulfopropyl methacrylate, sulfobutyl methacrylate, sulfomethyl acrylate, sulfoethyl acrylate, sulfopropyl acrylate and sulfobutyl acrylate, styrene, styrene sulfonate;
n is from 0 to 100.

6. The coated chlorothalonil particle according to claim 1, wherein the number average particle size distribution of the chlorothalonil particles as measured using laser light scattering with a particle refractive index of 1.6 and absorption of 0.01 is between 10 nm and 100 μm.

7. The coated chlorothalonil particle according to claim 1, wherein the weight % of polymer coating on the surface of the chlorothalonil particles is between 2% and 12%.

8. A process for preparing polymer coated chlorothalonil particles according to claim 1 comprising:
forming an aqueous suspension comprising chlorothalonil particles, a RAFT agent, one or more ethylenically unsaturated monomers;
polymerizing the one or more ethylenically unsaturated monomers under the control of the RAFT agent to thereby form a polymer coating on the surface of the chlorothalonil particle.

9. A process for preparing polymer coated chlorothalonil particles according to claim 8, wherein the polymerization of the one or more ethylenically unsaturated monomers under the control of the RAFT agent is initiated by adding a suitable radical initiator.

10. A process for preparing polymer coated chlorothalonil particles according to claim 8, comprising a further step of reducing the size of the chlorothalonil particles before the addition of monomers so as to obtain a number average particle size distribution of the chlorothalonil particles of between 10 nm and 100 μm.

11. A coated chlorothalonil particle obtained by the process as defined in claim 8.

12. An agrochemical composition comprising a fungicidally effective amount of a coated chlorothalonil particle according to claim 1.

13. The composition according to claim 12, further comprising at least one additional active ingredient and/or an agrochemically-acceptable diluent or carrier.

14. A method of controlling or preventing infestation of useful plants by phytopathogenic microorganisms, wherein a fungicidally effective amount of coated chlorothalonil according to claim 1, or a composition comprising this compound as active ingredient, is applied to the plants, to parts thereof or the locus thereof.

15. A method of reducing inhalation toxicity of chlorothalonil particles or compositions containing chlorothalonil particles, the method comprising polymer coating the chlorothalonil particles according to the method of claim 8.

16. The coated chlorothalonil particle according to claim 1, wherein the number average particle size distribution of the chlorothalonil particles as measured using laser light scattering with a particle refractive index of 1.6 and absorption of 0.01 is between 100 nm and 10 μm.

17. The coated chlorothalonil particle according to claim 1, wherein the number average particle size distribution of the chlorothalonil particles as measured using laser light scattering with a particle refractive index of 1.6 and absorption of 0.01 is between 1 μm and 3 μm.

18. The coated chlorothalonil particle according to claim 1, wherein the weight % of polymer coating on the surface of the chlorothalonil particles is between 2% and 10% of the total weight of the coated chlorothalonil particle.

19. The coated chlorothalonil particle according to any one of claims 1-6, wherein the weight % of polymer coating on the surface of the chlorothalonil particles is between 2% and 6% of the total weight of the coated chlorothalonil particle.

20. A process for preparing polymer coated chlorothalonil particles according to claim 9, wherein the radical initiator is 4,4′-azobis(4-cyanovaleric acid).
